(19) United States
(12) Patent Application Publication
(10) Pub. No.: US 2026/0171616 A1
(43) Pub. Date: Jun. 18, 2026

(54) BATTERY PACK

(71) Applicant: Samsung SDI Co., Ltd., Yongin-si (KR)

(72) Inventor: Jung Kyun Jung, Suwon-si (KR)

(73) Assignee: Samsung SDI Co., Ltd., Yongin-si (KR)

(21) Appl. No.: 19/357,646

(22) Filed: Oct. 14, 2025

(30) Foreign Application Priority Data
Dec. 13, 2024 (KR) 10-2024-0186057

(51) Int. Cl. H01M 50/505; H01M 50/24; H01M 50/242; H01M 50/262; H01M 50/271; H01M 50/291; H01M 50/293; H01M 50/507

(52) U.S. Cl. CPC H01M 50/505; H01M 50/24; H01M 50/242; H01M 50/262; H01M 50/271; H01M 50/291; H01M 50/293; H01M 50/507

(57) ABSTRACT

The present disclosure relates to a battery pack, and the technical problem to be solved is to provide a battery pack capable of increasing space utilization and preventing damage to components. To this end, the present disclosure provides a battery pack including a housing, one or more cell stacks disposed in the housing and including a plurality of battery cells arranged along a first direction, an end plate disposed to face the cell stack along the first direction, a slot disposed in the end plate, and a stack bus bar connected to the cell stack and inserted into the slot.

### CROSS-REFERENCE TO RELATED APPLICATIONS

This present application claims priority to and the benefit under 35 U.S.C. § 119(a)-(d) of Korean Patent Application No. 10-2024-0186057, filed on Dec. 13, 2024, the entire disclosure of which is incorporated herein by reference.

### FIELD

The present disclosure relates to a battery pack.

### BACKGROUND

In general, due to the recent proliferation of electronic devices using batteries, such as mobile phones, notebook computers, and electric vehicles, the demand for secondary batteries having high energy density and high capacity has rapidly increased. Accordingly, research and development for improving the performance of a lithium secondary battery are being actively conducted.

A lithium secondary battery is a battery including a positive electrode and a negative electrode including an active material capable of intercalating and deintercalating lithium ions, and an electrolyte solution, and generates energy through oxidation/reduction reactions when lithium ions are intercalated/deintercalated at the positive and negative electrodes.

Lithium secondary batteries can be used in the form of a battery pack including a plurality of battery cells connected in series and/or parallel and a battery management system (BMS) that controls charging and discharging of these plurality of battery cells.

The herein-described information disclosed in the technology that forms the background of the present disclosure is only intended to improve understanding of the background of the present disclosure, and thus may include information that does not constitute the related art.

### SUMMARY

The present disclosure is directed to providing a battery pack capable of increasing space utilization and preventing damage to components.

These and other aspects and features of the present disclosure will be described in or will be apparent from the following description of some embodiments of the present disclosure.

A battery pack according to the present disclosure includes: a housing; one or more cell stacks disposed in the housing and including a plurality of battery cells arranged along a first direction; an end plate disposed to face the cell stack along the first direction; a slot disposed in the end plate; and a stack bus bar connected to the cell stack and inserted into the slot.

The battery pack may further include a pressing member that is disposed in the slot and presses the stack bus bar.

The end plate may include a first inner wall and a second inner wall disposed to face the slot and spaced apart from one another along the first direction, and the pressing member may include a first pressing bracket that is disposed between the first inner wall and the stack bus bar and presses the stack bus bar toward the second inner wall.

The first pressing bracket may be elastically deformable.

The first pressing bracket may include: a first flange disposed parallel to the first inner wall; and a first bent portion connected to the first flange, bent around a second direction intersecting the first direction, and in contact with the stack bus bar.

The end plate may further include a first stopper that extends from the first inner wall to an inside of the slot and supports the first pressing bracket.

The pressing member may further include a first slit passing through the first pressing bracket, and the first stopper may be inserted into the first slit.

The pressing member may further include a second pressing bracket spaced from the first pressing bracket along a second direction intersecting the first direction.

A distance from a center line of the battery cell to the second pressing bracket may be greater than a distance from the center line of the battery cell to the first pressing bracket.

A plurality of second pressing brackets may be provided, and the plurality of second pressing brackets may be symmetrically disposed on both sides of the first pressing bracket.

A thickness of the first pressing bracket may be smaller than a thickness of at least one of the second pressing brackets.

The housing may include: a housing body; a first frame disposed in the housing body and extending along the first direction; and a second frame disposed in the housing body and extending along a second direction intersecting the first direction, and the end plate may be disposed between the second frame and the cell stack.

The battery pack may further include: a fastening hole passing through the second frame; and a hook protruding from the end plate and inserted into the fastening hole.

The fastening hole may pass through the second frame along the first direction, and the end plate may include a fastening body that supports the hook and is elastically deformable along the first direction.

The battery pack may further include a fixing member that is disposed between the second frame and the end plate and presses the end plate toward the cell stack, wherein the fixing member may be inserted between the second frame and the end plate along a third direction intersecting the first direction and the second direction.

The fixing member may include a first inclined surface disposed to be inclined with respect to the third direction, and the end plate may include a second inclined surface disposed parallel to the first inclined surface.

The battery pack may further include: a plurality of first sawteeth protruding from the first inclined surface; and a plurality of second sawteeth protruding from the second inclined surface and engaged with and coupled to the first sawteeth.

The battery pack may further include a reinforcement member disposed between the end plate and the cell stack.

The end plate may be formed of a plastic material, and the reinforcement member may be formed of a metal material.

The battery pack may further include a slot cover that is coupled to the end plate and seals the slot.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a perspective view schematically showing a configuration of a battery pack according to embodiments of the present disclosure;

FIG. 2 is an exploded perspective view schematically showing the configuration of the battery pack according to embodiments of the present disclosure;

FIG. 3 is a perspective view schematically showing a configuration of a battery cell according to embodiments of the present disclosure;

FIG. 4 is a cross-sectional view schematically showing the configuration of the battery cell according to embodiments of the present disclosure;

FIG. 5 is a view schematically showing a configuration of an electrode assembly according to a first embodiment of the present disclosure;

FIG. 6 is an enlarged view schematically showing a configuration of an end plate according to embodiments of the present disclosure;

FIG. 7 is a cross-sectional view taken along line VII-VII′ in FIG. 6;

FIG. 8 is a perspective view schematically showing a configuration of a first pressing bracket according to embodiments of the present disclosure;

FIG. 9 is a cross-sectional view taken along line IX-IX′ in FIG. 1;

FIG. 10 is a perspective view schematically showing a configuration of a second pressing bracket according to embodiments of the present disclosure;

FIG. 11 is a perspective view schematically showing a configuration of a fastening hole and a hook according to embodiments of the present disclosure;

FIG. 12 is a cross-sectional view schematically showing the configuration of the fastening hole and the hook according to embodiments of the present disclosure;

FIG. 13 is an exploded perspective view schematically showing a configuration of a battery pack according to embodiments of the present disclosure;

FIG. 14 is a cross-sectional view schematically showing a configuration of a fixing member according to embodiments of the present disclosure;

FIG. 15 is a view showing a state in which the fixing member is disposed between a second frame and an end plate in FIG. 14; and

FIG. 16 is an enlarged view schematically showing a configuration of a first sawtooth and a second sawtooth according to embodiments of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

Embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

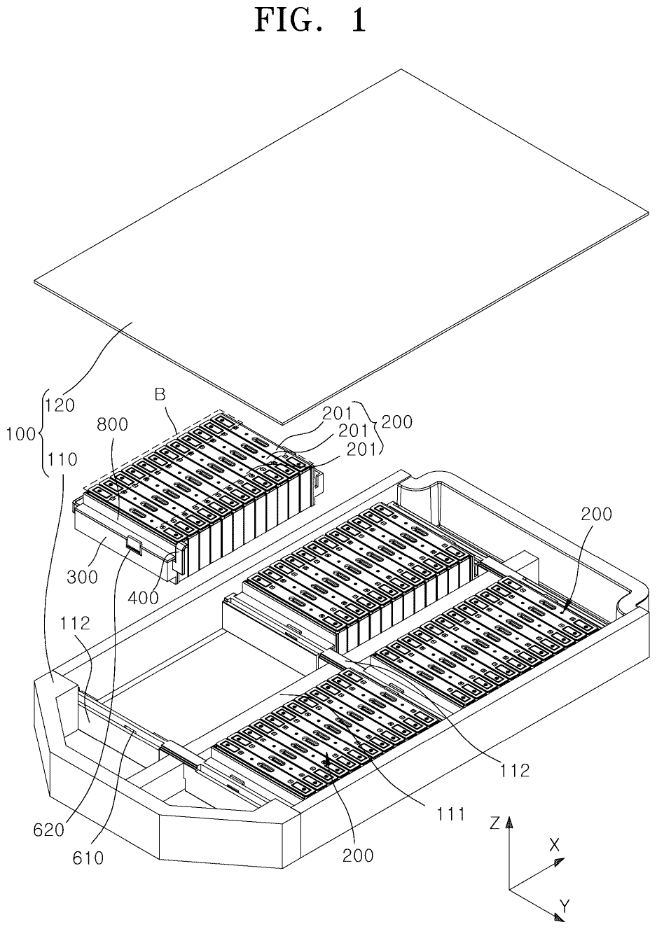

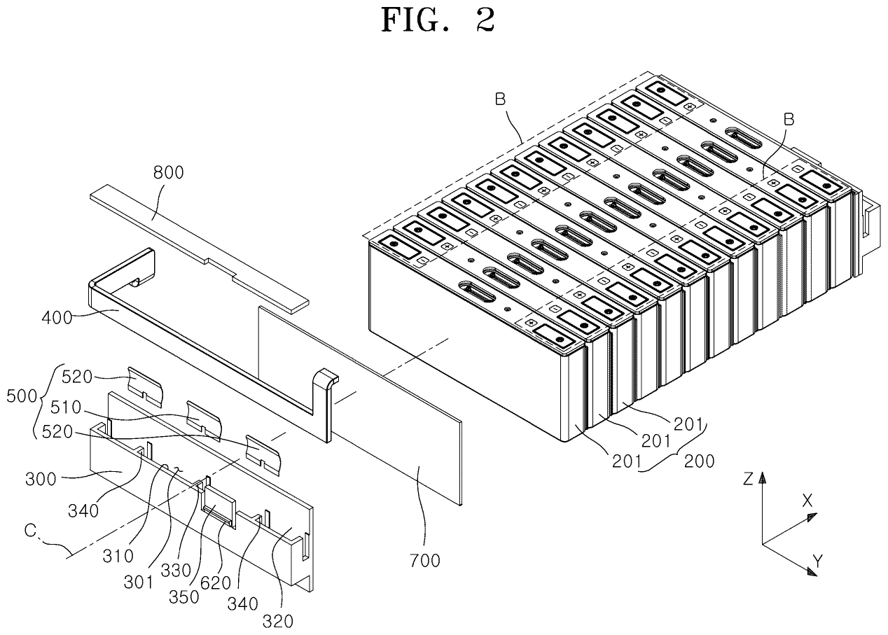

FIG. 1 is a perspective view schematically showing a configuration of a battery pack according to embodiments of the present disclosure, and FIG. 2 is an exploded perspective view schematically showing the configuration of the battery pack according to embodiments of the present disclosure.

A first direction described herein may be exemplified as a direction parallel to an X-axis based on FIG. 1, a second direction described herein may be exemplified as a direction parallel to a Y-axis based on FIG. 1, and a third direction described herein may be exemplified as a direction parallel to a Z-axis based on FIG. 1.

Referring to FIGS. 1 and 2, the battery pack according to embodiments may include a housing 100, a cell stack 200, an end plate 300, a slot 301, and a stack bus bar 400.

The housing 100 may form an approximate exterior of the battery pack and provide a space in which the cell stack 200 may be accommodated. The housing 100 may protect the cell stack 200 from an external impact and foreign substances.

The housing 100 may include a housing body 110.

The housing body 110 may be formed to have a shape of a box with an empty interior and one open side. For example, the open side of the housing body 110 may be disposed perpendicular to the third direction based on FIG. 1 and face upward. A cross-sectional shape of the housing body 110 is not limited to the shape shown in FIG. 1 and may be designed to have various shapes such as a polygonal shape, a circular shape, an oval shape, and the like.

The housing 100 may further include a first frame 111 and a second frame 112.

The first frame 111 and the second frame 112 may be disposed in the housing body 110. The first frame 111 and the second frame 112 may partition a space in which the cell stack 200 is accommodated in the housing body 110 and support the cell stack 200.

The first frame 111 according to embodiments may extend along the first direction. That is, the first frame 111 may have a rod shape whose longitudinal direction is disposed parallel to the first direction. A plurality of first frames 111 may be provided. The plurality of first frames 111 may be arranged at a certain interval along the second direction. The plurality of first frames 111 may be disposed parallel to each other.

The second frame 112 according to embodiments may extend along the second direction. That is, the second frame 112 may have a rod shape whose longitudinal direction is disposed parallel to the second direction. A plurality of second frames 112 may be provided. The plurality of second frames 112 may be arranged at a certain interval along the first direction. The plurality of second frames 112 may be disposed parallel to each other.

In embodiments, the first frame 111 and the second frame 112 may be disposed to form a grid pattern that intersects each other perpendicularly in the housing body 110.

The housing 100 according to embodiments may further include a housing cover 120.

The housing cover 120 may be coupled to the housing body 110 and may close an inner space of the housing body 110. For example, the housing cover 120 may be formed to have a substantially plate shape. The housing cover 120 may be disposed to face an upper side surface of the housing body 110 along the third direction. The housing cover 120 may be fixed to an upper end portion of the housing body 110 by various types of coupling methods such as bolting, welding, fitting, and the like.

The cell stack 200 may be disposed in the housing 100. One or more cell stacks 200 may be provided. Hereinafter, an example in which a plurality of cell stacks 200 are formed will be described, but the present disclosure is not limited thereto, and a single cell stack 200 may also be formed. Each of the cell stacks 200 may be individually disposed in the inner space of the housing body 110 partitioned by the first frames 111 and the second frames 112 different from each other. For example, each of the cell stacks 200 may be individually disposed in a space surrounded by a pair of first frames 111 and a pair of second frames 112.

Each of the cell stacks 200 may include a battery cell 201.

The battery cell 201 may function as a unit structure which stores and supplies power in the battery pack. A plurality of battery cells 201 may be provided. The plurality of battery cells 201 may be arranged along the first direction. However, the arrangement of the plurality of battery cells 201 is not limited thereto, and the plurality of battery cells 201 may be arranged in a plurality of rows along the second direction, or may also be arranged in a plurality of rows along the first and second directions.

The plurality of battery cells 201 may be electrically connected by one or more bus bars B. The plurality of battery cells 201 may be connected in various ways by the bus bar B such as in series, in parallel, or in a combination of series and parallel.

Hereinafter, an example in which the battery cell 201 is a prismatic battery as a lithium-ion secondary battery will be described. However, the present disclosure is not limited thereto, and the battery cell 201 may be a lithium polymer battery or a cylindrical battery.

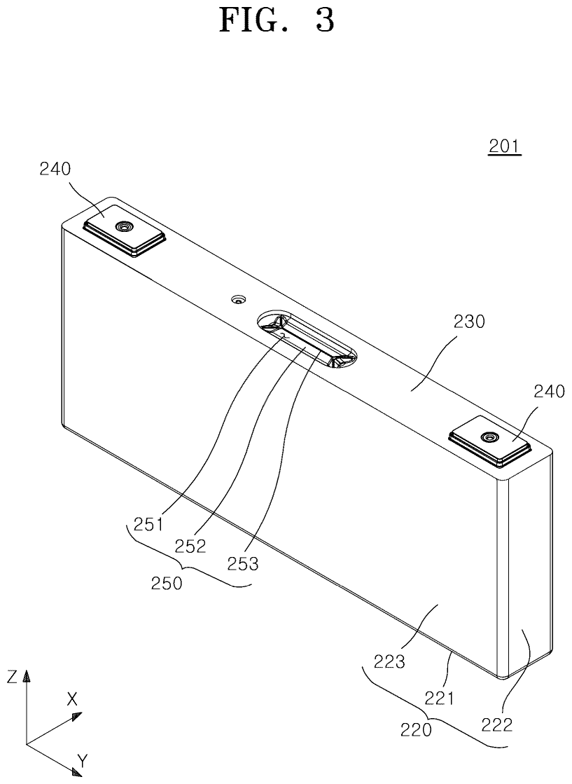

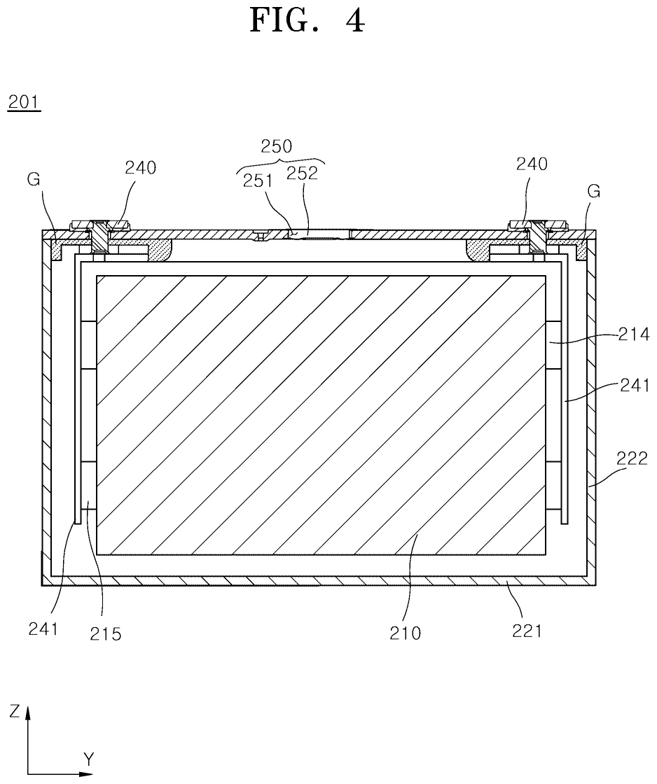

FIG. 3 is a perspective view schematically showing a configuration of the battery cell according to embodiments of the present disclosure, and FIG. 4 is a cross-sectional view schematically showing the configuration of the battery cell according to embodiments of the present disclosure.

Referring to FIGS. 1 to 4, the battery cell 201 according to embodiments includes an electrode assembly 210, a case 220, a cap plate 230, a terminal 240, and a vent 250.

The electrode assembly 210 may function as a unit structure which performs charging and discharging operations of power in the battery cell 201. The electrode assembly 210 may be accommodated in the case 220.

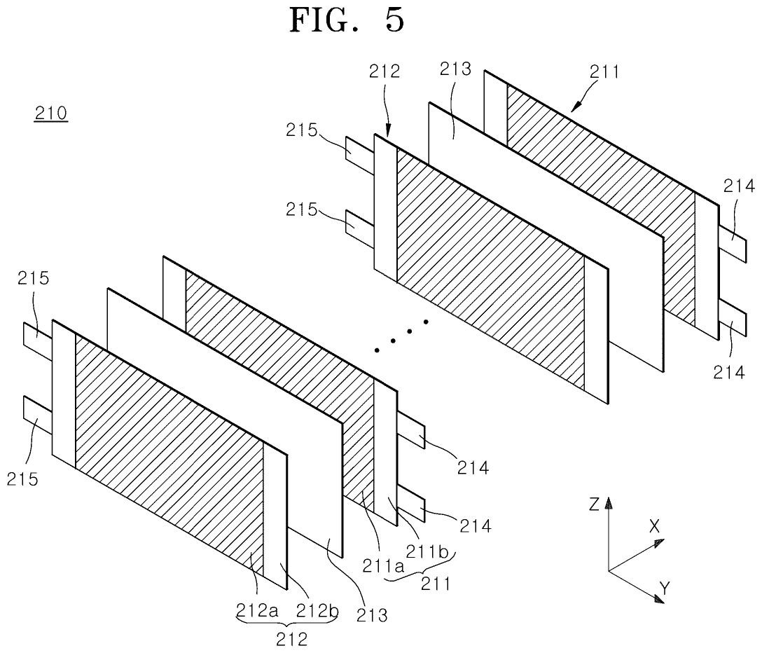

FIG. 5 is a view schematically showing a configuration of an electrode assembly according to a first embodiment of the present disclosure.

Referring to FIGS. 1 to 5, the electrode assembly 210 according to embodiments may include a first electrode 211, a second electrode 212, and a separator 213.

Hereinafter, an example in which the electrode assembly 210 is formed as a stack type in which a plurality of first electrodes 211, a plurality of second electrodes 212, and a plurality of separators 213 are alternately stacked along the first direction will be described. However, the electrode assembly 210 is not limited thereto, and may also be formed as a jelly roll type wound around a winding axis in a state in which the first electrodes 211, the second electrodes 212, and the separators 213 are sequentially stacked.

The first electrode 211 may function as a positive electrode of the electrode assembly 210.

The first electrode 211 according to embodiments may be formed to have a foil shape including a metal material such as aluminum or an aluminum alloy. Both surfaces of the first electrode 211 may be disposed perpendicular to the first direction. The type, size, shape or the like of the first electrode 211 is not particularly limited as long as it has conductivity and does not cause a chemical change in the secondary battery. A shape of the first electrode 211 may be designed to have various shapes in addition to the rectangular shape.

A plurality of first electrodes 211 may be provided. The plurality of first electrodes 211 may be arranged along the first direction. The number of first electrodes 211 may be designed in various ways depending on the charging capacity and the like of the battery cell 201.

The first electrode 211 may include a first active material layer 211a.

The first active material layer 211a may be provided in a form of being applied on at least a portion of the first electrode 211. The first active material layer 211a may be applied on both surfaces of the first electrode 211 or alternatively, may be applied on only one surface of the first electrode 211.

As the first electrode 211 functions as a positive electrode in embodiments, the first active material layer 211a may include a positive electrode active material.

The positive electrode active material may be a compound capable of reversible intercalation and deintercalation of lithium (a lithiated intercalation compound). More specifically, as the positive electrode active material, one or more of composite oxides of a metal selected from the group consisting of cobalt, manganese, nickel, iron, and a combination thereof and lithium may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1,0<y<1,0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM) or may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first active material layer 211a may further include a positive electrode conductive material.

The positive electrode conductive material is used to impart conductivity to the first active material layer 211a, and any electronically conductive material that does not cause a chemical change may be used. Examples of the positive electrode conductive material may include carbon-based materials such as natural graphite, artificial graphite, carbon black, acetylene black, Ketjen black, carbon fibers, carbon nanofibers, and carbon nanotubes, metal-based materials in the form of a metal powder or metal fibers containing copper, nickel, aluminum, silver, and the like, conductive polymers such as polyphenylene derivatives, or a mixture thereof.

The first active material layer 211a may further include a positive electrode binder.

The positive electrode binder serves to attach the particles constituting the positive electrode active material to each other well, and also attach the positive electrode active material to the first electrode 211 well.

Examples of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the positive electrode binder, the aqueous binder may further include a cellulose series compound capable of imparting viscosity. As the cellulose series compound, one or more of carboxymethyl cellulose, hydroxypropylmethyl cellulose, methyl cellulose, and an alkali metal salt thereof may be mixed and used. The alkali metal may be Na, K, or Li.

The dry binder may be a polymer material capable of being fiberized, for example, polytetrafluoroethylene, polyvinylidene fluoride, a polyvinylidene fluoride-hexafluoropropylene copolymer, polyethylene oxide, or a combination thereof.

The first electrode 211 may include a first uncoated portion 211b on which the first active material layer 211a is not applied. The first uncoated portion 211b according to embodiments may be disposed in one end region of the first electrode 211 facing the second direction. However, the first uncoated portion 211b is not limited to this form, and may also be formed over an entire edge region of the first electrode 211.

The second electrode 212 may function as a negative electrode of the electrode assembly 210.

The second electrode 212 according to embodiments may be formed to have a foil shape including a metal material such as copper, a copper alloy, nickel, or a nickel alloy. Both surfaces of the second electrode 212 may be disposed perpendicular to the first direction. The type, size, shape or the like of the second electrode 212 is not specifically limited as long as it has conductivity and does not cause a chemical change in the secondary battery. A cross-Attorney sectional shape of the second electrode 212 may be designed to have various shapes in addition to the rectangular shape shown in FIG. 4.

A plurality of second electrodes 212 may be provided. The plurality of second electrodes 212 may be arranged along the first direction. The plurality of first electrodes 211 and second electrodes 212 may be alternately disposed along the first direction.

The second electrode 212 may include a second active material layer 212a and a second uncoated portion 212b.

The second active material layer 212a may be provided in a form of being applied on at least a portion of the second electrode 212. The second active material layer 212a may be applied on both surfaces of the second electrode 212, or alternatively, may be applied on only one surface of the second electrode 212.

As the second electrode 212 functions as a negative electrode, the second active material layer 212a may include a negative electrode active material.

The negative electrode active material may include a material capable of reversible intercalation/deintercalation of lithium ions, a lithium metal, a lithium metal alloy, a material capable of doping and dedoping of lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite such as amorphous, plate-like, flake-like, spherical, or fiber-like natural graphite or artificial graphite, and examples of the amorphous carbon may include soft carbon, hard carbon, mesophase pitch carbide, calcined coke, or the like.

As the lithium metal alloy, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedepoing of lithium, a Si-based negative electrode active material or a Sn-based negative electrode active material may be used. The Si-based negative electrode active material may be silicon, a silicon-carbon composite, SiOx (0<x≤2), a Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnOx(0<x≤2, e.g., SnO₂), a Sn-based alloy, or a combination thereof.

The silicon-carbon composite may be a composite of silicon and amorphous carbon. According to embodiments, the silicon-carbon composite may be in the form of silicon particles and amorphous carbon coated on surfaces of the silicon particles. For example, the silicon-carbon composite may include a secondary particle (core) in which primary silicon particles are aggregated and an amorphous carbon coating layer (shell) located on a surface of the secondary particle. The amorphous carbon may be located between the primary silicon particles, for example, so that the primary silicon particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si-based negative electrode active material or Sn-based negative electrode active material may be used in combination with a carbon-based negative electrode active material.

The second active material layer 212a may further include a negative electrode conductive material and a negative electrode binder.

The negative electrode conductive material is used to impart conductivity to the second active material layer 212a, and any electronically conductive material that does not cause a chemical change may be used. Examples of the negative electrode conductive material may include carbon-based materials such as natural graphite, artificial graphite, carbon black, acetylene black, Ketjen black, carbon fibers, carbon nanofibers, and carbon nanotubes, metal-based materials in the form of a metal powder or metal fibers containing copper, nickel, aluminum, silver, or the like, conductive polymers such as polyphenylene derivatives, or a mixture thereof.

The negative electrode binder serves to well attach particles constituting the negative electrode active material and also serves to well attach the negative electrode active material to the second electrode 212.

Examples of the negative electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose series compound capable of giving viscosity. As the cellulose series compound, one or more of carboxymethyl cellulose, hydroxypropylmethyl cellulose, methyl cellulose, and an alkali metal salt thereof may be mixed and used. The alkali metal may be Na, K, or Li.

The dry binder may be a polymer material capable of being fiberized, for example, polytetrafluoroethylene, polyvinylidene fluoride, a polyvinylidene fluoride-hexafluoropropylene copolymer, polyethylene oxide, or a combination thereof.

The second electrode 212 may include a second uncoated portion 212b on which the second active material layer 212a is not applied. The second uncoated portion 212b according to embodiments may be disposed in an end region of the second electrode 212. However, the second uncoated portion 212b is not limited to this form, and may be formed over an entire edge region of the second electrode 212.

The separator 213 may be disposed between the first electrode 211 and the second electrode 212. The separator 213 may perform a function of preventing a short circuit between the first electrode 211 and the second electrode 212 while allowing lithium ions to move between the first electrode 211 and the second electrode 212. The separator 213 may be disposed to entirely surround a surface region of the electrode assembly 210. Accordingly, the separator 213 may prevent the first electrode 211 and the second electrode 212 from being directly exposed to the outside of the electrode assembly 210.

The separator 213 may be made of polyethylene, polypropylene, polyvinylidene fluoride, or a multilayer film of two or more layers thereof, and a mixed multilayer film such as a two-layer separator of polyethylene/polypropylene, a three-layer separator of polyethylene/polypropylene/polyethylene, or a three-layer separator of polypropylene/polyethylene/polypropylene may be used.

The separator 213 may include a porous substrate and a coating layer including an organic material, an inorganic material, or a combination thereof, which is positioned on one surface or both surfaces of the porous substrate.

The porous substrate may be a polymer film made of one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, and polytetrafluoroethylene, or a copolymer or mixture of two or more of the herein materials.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer or may be in the form of a coating layer including (or containing) an organic material and a coating layer including (or containing) an inorganic material which are stacked on each other.

The electrode assembly 210 according to embodiments may further include a first tab 214 and a second tab 215.

The first tab 214 may be connected to the first electrode 211.

The first tab 214 according to embodiments may have a foil shape extending from the first uncoated portion 211b of the first electrode 211 in a direction parallel to the second direction. The first tab 214 may have a substantially rectangular shape. However, the shape of the first tab 214 is not limited thereto and may be designed to have various shapes.

The first tab 214 may be formed integrally with the first electrode 211. For example, the first tab 214 may be the remaining region of the first uncoated portion 211b which remains after a partial region of the first uncoated portion 211b is cut or removed by notching processing or the like. Alternatively, the first tab 214 may be manufactured separately from the first electrode 211 and then connected to the first uncoated portion 211b by welding or the like. A material of the first tab 214 may be the same as a material of the first electrode 211.

A plurality of first tabs 214 may be provided. Each of the first tabs 214 may individually extend from the first uncoated portions 211b of different first electrodes 211. Neighboring first tabs 214 may be disposed to face each other along the first direction. That is, the plurality of first tabs 214 may be arranged along the first direction. The neighboring first tabs 214 may be disposed parallel to each other. The neighboring first tabs 214 may be in contact with each other and may also be spaced apart from each other by a thickness of the separator 213.

The plurality of first tabs 214 may be provided on each first electrode 211. For example, a pair of first tabs 214 may be formed on each first electrode 211. The pair of first tabs 214 formed on each first electrode 211 may be arranged along the third direction.

The second tab 215 may be connected to the second electrode 212.

The second tab 215 according to embodiments may have a foil shape extending from the second uncoated portion 212b of the second electrode 212 in a direction parallel to the second direction. Extending directions of the first tab 214 and the second tab 215 may be opposite to each other. The second tab 215 may have a substantially rectangular shape. However, the shape of the second tab 215 is not limited thereto and may be designed to have various shapes.

The second tab 215 may be formed integrally with the second electrode 212. For example, the second tab 215 may be the remaining region of the second uncoated portion 212b which remains after a partial region of the second uncoated portion 212b is cut or removed by notching processing or the like. Alternatively, the second tab 215 may be manufactured separately from the second electrode 212 and then connected to the second uncoated portion 212b by welding or the like. A material of the second tab 215 may be the same as a material of the second electrode 212.

A plurality of second tabs 215 may be provided. Each of the second tabs 215 may individually extend from the second uncoated portions 212b of different second electrodes 212. Neighboring second tabs 215 may be disposed to face each other along the first direction. That is, the plurality of second tabs 215 may be arranged along the first direction. The neighboring second tabs 215 may be disposed parallel to each other. The neighboring second tabs 215 may be in contact with each other and also spaced apart from each other by the thickness of the separator 213.

The plurality of second tabs 215 may be provided on each second electrode 212. For example, a pair of second tabs 215 may be formed on each second electrode 212. The pair of second tabs 215 formed on each second electrode 212 may be arranged along the third direction.

The case 220 may form an approximate exterior of the battery cell 201 and may accommodate the electrode assembly 210. The case 220 may include a conductive metal material such as aluminum, an aluminum alloy, or nickel-plated steel.

The case 220 according to embodiments may include a bottom portion 221, a first side portion 222, and a second side portion 223.

The bottom portion 221 may form an exterior of a lower side of the case 220. The bottom portion 221 according to embodiments may have a rectangular plate shape. The bottom portion 221 may be disposed to face a bottom surface of the housing body 110. The bottom portion 221 may be disposed to face the bottom surface of the housing body 110 along the third direction.

The first side portion 222 may extend from the bottom portion 221 and form a portion of an exterior of a side surface of the case 220.

The first side portion 222 according to embodiments may have a rectangular plate shape extending from the bottom portion 221 in a direction parallel to the third direction. The first side portion 222 may be disposed perpendicular to the second direction. A lower end portion of the first side portion 222 may be connected to an edge of the bottom portion 221 disposed parallel to the first direction. An upper end portion of the first side portion 222 may be disposed to face the housing cover 120. The upper end portion of the first side portion 222 may be disposed to face the housing cover 120 along the third direction.

A pair of first side portions 222 may be provided. The pair of first side portions 222 may be disposed spaced apart at a certain interval and may face each other along the second direction. The pair of first side portions 222 may be disposed parallel to each other.

The second side portion 223 may extend from the bottom portion 221 and may form the remaining portion of the exterior of the side surface of the case 220.

The second side portion 223 according to embodiments may have a rectangular plate shape extending from the bottom portion 221 in the direction parallel to the third direction. The second side portion 223 may be disposed to intersect the first side portion 222. For example, the second side portion 223 may be disposed perpendicular to the first direction.

A lower end portion of the second side portion 223 may be connected to an edge of the bottom portion 221 disposed parallel to the second direction. An upper end portion of the second side portion 223 may be disposed to face the housing cover 120. The upper end portion of the second side portion 223 may be disposed to face the housing cover 120 along the third direction.

An area of the second side portion 223 may be larger than an area of the first side portion 222.

A pair of second side portions 223 may be provided. The pair of second side portions 223 may be disposed spaced apart at a certain interval and may face each other along the first direction. The pair of second side portions 223 may be disposed parallel to each other.

Accordingly, the case 220 according to embodiments may have a rectangular parallelepiped shape having an open upper end portion facing the housing cover 120.

The cap plate 230 may be coupled to the case 220 and may seal the case 220.

The cap plate 230 according to embodiments may be formed to have a flat plate shape. The cap plate 230 may be disposed to face the case 220 along the third direction. For example, an inner side surface of the cap plate 230 may be disposed to face the open upper side surface of the case 220. An outer side surface of the cap plate 230 may be disposed to face an inner side surface of the housing cover 120. The cap plate 230 may be disposed parallel to the bottom portion 221 of the case 220 and the housing cover 120.

The cap plate 230 may be seated on upper end portions of the second side portion 223 and the first side portion 222. Alternatively, the cap plate 230 may be inserted into the case 220 and a peripheral surface thereof may be in contact with inner side surfaces of the second side portion 223 and the first side portion 222. The cap plate 230 may be coupled to the upper end portions of the second side portion 223 and the first side portion 222 by various types of coupling methods such as welding, bolting, fitting, and the like.

The terminal 240 may be coupled to the cap plate 230 and may protrude outward from the cap plate 230. The terminal 240 may be electrically connected to the electrode assembly 210.

The terminal 240 according to embodiments may pass through the cap plate 230 along the third direction. An upper end portion of the terminal 240 may protrude outward from the cap plate 230, and a lower end portion of the terminal 240 may protrude into the case 220. A specific shape of the terminal 240 is not limited to the shape shown in FIGS. 2 to 3 and may be designed to have various shapes.

The terminal 240 may be formed of an electrically conductive material such as aluminum, nickel, copper, or the like.

A pair of terminals 240 may be provided. The pair of terminals 240 may be disposed spaced apart from each other at a certain interval on the cap plate 230 along the second direction.

The pair of terminals 240 may be individually connected to the first electrode 211 and the second electrode 212 of the electrode assembly 210. Accordingly, the pair of terminals 240 may respectively function as a positive electrode terminal and a negative electrode terminal of the battery cell 201.

For example, any one terminal 240 of the pair of terminals 240 may be connected to the first tab 214. Any one of the pair of terminals 240 may be indirectly connected to the first tab 214 through a current collector 241 welded to the first tab 214. Alternatively, the terminal 240 may be directly connected to the first tab 214.

Further, the other terminal 240 of the pair of terminals 240 may be connected to the second tab 215. The other terminal 240 of the pair of terminals 240 may be indirectly connected to the second tab 215 through a current collector 241 welded to the second tab 215. Alternatively, the terminal 240 may be directly connected to the second tab 215.

An insulator G may be installed between the electrode assembly 210 and the cap plate 230. A pair of insulators G may be provided. The pair of insulators G may be spaced apart from each other between the electrode assembly 210 and the cap plate 230 along the second direction. The pair of insulators G may be disposed to individually surround different terminals 240. The insulator G may be formed of an insulating material such as polyethylene (PE), polypropylene (PP), polyethylene terephthalate (PET), rubber, or the like.

The vent 250 may be installed in the cap plate 230 and may be opened and closed in response to a change in internal pressure of the case 220. The vent 250 may function as a configuration providing a discharge path for gas, flames, smoke, or the like generated in the case 220 when the internal pressure of the case 220 rises above a set magnitude due to overcurrent, thermal runaway, or the like. The vent 250 may be disposed between the pair of terminals. A longitudinal direction of the vent 250 described herein may mean a direction parallel to the second direction, and a width direction of the vent 250 may mean a direction parallel to the first direction.

The vent 250 may include a vent hole 251 and a vent plate 252.

The vent hole 251 may be formed to have a hole shape passing through the cap plate 230 along the third direction. A lower side of the vent hole 251 may be connected to an inner space of the case 220. An upper side of the vent hole 251 may be connected to the space outside the cap plate 230. A cross-sectional shape of the vent hole 251 may be designed to have various shapes such as an oval shape, a circular shape, a polygonal shape, and the like.

The vent plate 252 may be opened and closed in response to a change in internal pressure of the case 220. That is, the vent plate 252 may maintain a closed state during normal operation of the battery cell 201 to seal the case 220. The vent plate 252 may be opened as the internal pressure of the case 220 rises above a set magnitude due to overcharging of the battery cell 201, the occurrence of fire, or the like and may discharge flames, gas, smoke, and the like generated inside the case 220 to the outside of the case 220.

The vent plate 252 according to embodiments may be formed to have a flat plate shape. The vent plate 252 may be disposed to face the vent hole 251 along the third direction. A thickness of the vent plate 252 may be smaller than a thickness of the cap plate 230. An upper surface of the vent plate 252 may be coupled to a lower surface of the cap plate 230 by various types of coupling methods such as welding, bolting, fitting, and the like. Alternatively, the vent plate 252 may be inserted into the vent hole 251, and a peripheral surface of the vent plate 252 may be coupled to an inner side surface of the vent hole 251.

A vent notch 253 may be formed in the vent plate 252 to induce a rupture operation of the vent plate 252. The vent notch 253 according to embodiments may have a groove shape concavely recessed toward the inside of the vent plate 252 from an outer surface of the vent plate 252. The shape of the vent notch 253 is not limited to the shape shown in FIG. 2, and may be formed to have various patterns on the vent plate 252.

The end plate 300 may be disposed in the housing 100 to face the cell stack 200 along the first direction. The end plate 300 may support the cell stack 200 along the first direction in which the plurality of battery cells 201 are arranged.

A plurality of end plates 300 may be provided. The pair of end plates 300 may be symmetrically disposed on both sides of each cell stack 200 along the first direction with the cell stack 200 therebetween.

The pair of end plates 300 disposed on both sides of each cell stack 200 may press the cell stack 200 in the first direction and an opposite direction of the first direction, respectively. That is, the pair of end plates 300 may press the cell stack 200 in directions closer to each other.

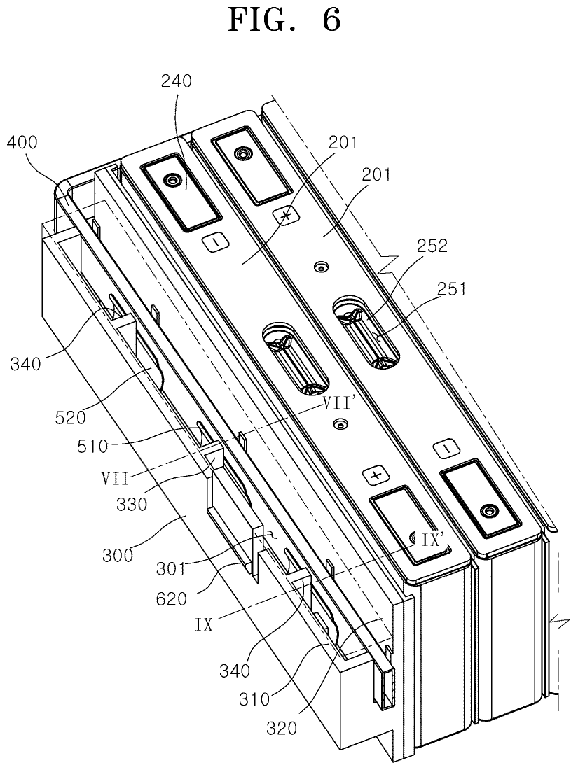

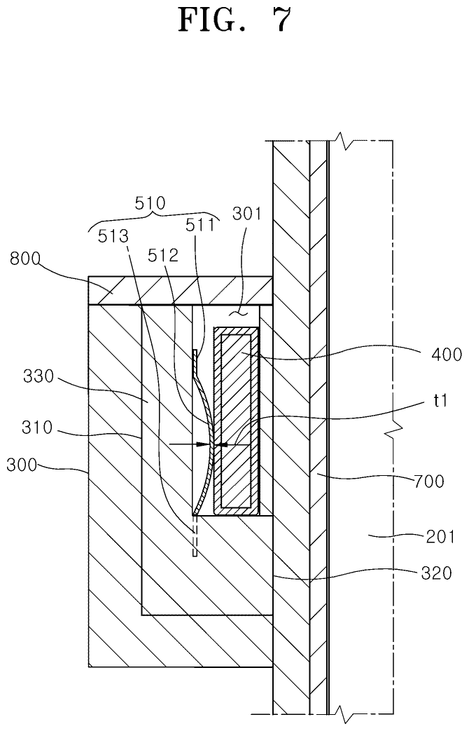

FIG. 6 is an enlarged view schematically showing a configuration of the end plate according to embodiments of the present disclosure, and FIG. 7 is a cross-sectional view taken along line VII-VII′ in FIG. 6.

Referring to FIGS. 1 to 7, the end plate 300 according to embodiments may be disposed between the second frame 112 and the cell stack 200. For example, the end plate 300 may be disposed between the outermost battery cell 201 among the battery cells 201 arranged along the first direction in the cell stack 200 and the second frame 112.

One surface of the end plate 300 may be disposed to face the second side portion 223 of the outermost battery cell 201 among the battery cells 201 arranged along the first direction. The other surface of the end plate 300 may be disposed to face the second frame 112.

The end plate 300 may be formed of a plastic material such as polypropylene (PP) or the like to secure insulation with the battery cell 201.

The slot 301 may be disposed in the end plate 300. The slot 301 may provide a space in which the stack bus bar 400 described herein is accommodated in the end plate 300.

The slot 301 according to embodiments may be exemplified as an empty space formed in the end plate 300. A portion of the upper side surface of the slot 301 perpendicular to the third direction and portions of both side surfaces of the slot 301 perpendicular to the second direction may be formed to be opened.

The end plate 300 according to embodiments may include a first inner wall 310 and a second inner wall 320 disposed to face the slot 301 and spaced apart from each other along the first direction.

In embodiments, the first inner wall 310 may be exemplified as a surface which is perpendicular to the first direction and is disposed to face the cell stack 200 among inner side surfaces of the end plate 300 surrounding the side surface of the slot 301. Further, the second inner wall 320 may be exemplified as a surface which is perpendicular to the first direction and is disposed to face the first inner wall 310 among inner side surfaces of the end plate 300 surrounding the side surface of the slot 301.

The stack bus bar 400 may be connected to the cell stack 200. The stack bus bar 400 may function as a configuration providing an electrical connection between different cell stacks 200 or between the cell stack 200 and an external electronic device.

The stack bus bar 400 according to embodiments may be connected to the cell stack 200 through the bus bar B which connects the plurality of battery cells 201. The stack bus bar 400 may be connected to the bus bar B by various types of coupling methods such as welding, bolting, and the like. The stack bus bar 400 may be formed of an electrically conductive material such as copper, aluminum, nickel, or the like.

The stack bus bar 400 may extend from the bus bar B to the outside of the cell stack 200. A portion of the stack bus bar 400 extending to the outside of the cell stack 200 may be inserted into the slot 301. Both surfaces of the stack bus bar 400 inserted into the slot 301 may be disposed to face the first inner wall 310 and the second inner wall 320 in parallel, respectively. Accordingly, the battery pack according to embodiments may reduce an installation space of the stack bus bar 400 and protect the stack bus bar 400 from foreign substances, moisture, and the like.

A plurality of stack bus bars 400 may be provided. A pair of stack bus bars 400 may be connected to each cell stack 200. The pair of stack bus bars 400 connected to one cell stack 200 may be spaced apart along the first direction and may be disposed on both sides of the cell stack 200. The pair of stack bus bars 400 disposed on both sides of the cell stack 200 may be individually inserted into the slots 301 formed in different end plates 300.

The battery pack according to embodiments may further include a pressing member 500.

The pressing member 500 may be disposed in the slot 301. The pressing member 500 may function as a configuration which firmly fixes the stack bus bar 400 in the slot 301 by pressing the stack bus bar 400 toward the end plate 300.

A plurality of pressing members 500 may be provided. Each of the pressing members 500 may be individually disposed in different slots 301.

The pressing member 500 according to embodiments may include a first pressing bracket 510.

The first pressing bracket 510 may be disposed between the first inner wall 310 and the stack bus bar 400. The first pressing bracket 510 may be disposed to face a center of the battery cell 201. More specifically, a center line C of the battery cell 201 passing through the center of the battery cell 201 along the first direction may pass through the first pressing bracket 510. In embodiments, the battery cell 201 may be symmetrically divided along the second direction and the third direction based on the center line C.

The first pressing bracket 510 may press the stack bus bar 400 toward the second inner wall 320. The first pressing bracket 510 may be provided to be elastically deformable. Accordingly, the first pressing bracket 510 may always apply a pressing force to the stack bus bar 400 by its own elastic force without a separate power device.

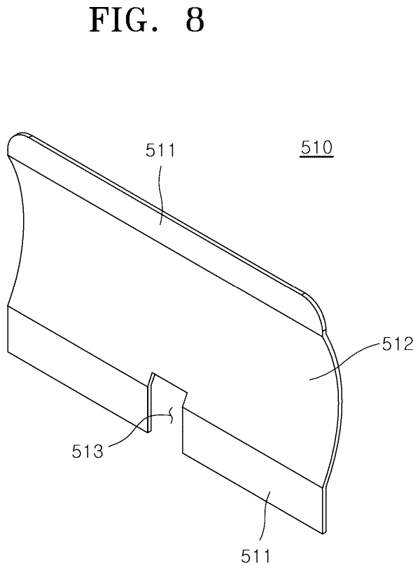

FIG. 8 is a perspective view schematically showing a configuration of the first pressing bracket according to embodiments of the present disclosure.

Referring to FIGS. 6 to 8, the first pressing bracket 510 according to embodiments of the present disclosure may include a first flange 511 and a first bent portion 512.

The first flange 511 may form an exterior of one side of the first pressing bracket 510 and support the first bent portion 512.

The first flange 511 according to embodiments may have a flat plate shape disposed parallel to the first inner wall 310. A pair of first flanges 511 may be provided. The pair of first flanges 511 may be disposed spaced apart from each other at a certain interval along the third direction.

The first bent portion 512 may be connected to the first flange 511 and may form an exterior of the center of the first pressing bracket 510.

The first bent portion 512 according to embodiments may be disposed between the pair of first flanges 511. Both end portions of the first bent portion 512 may be connected to different first flanges 511, respectively. The first bent portion 512 may be convexly bent toward the stack bus bar 400 around the second direction. The first bent portion 512 may be in contact with the stack bus bar 400 and may press the stack bus bar 400 toward the second inner wall 320 by an elastic force due to the bending.

The end plate 300 according to embodiments may further include a first stopper 330 for supporting the first pressing bracket 510 in the slot 301.

The first stopper 330 according to embodiments may have a form of a partition wall extending from the first inner wall 310 toward an inner space of the slot 301. The pair of first flanges 511 may be supported by being in contact with a surface of the first stopper 330 disposed parallel to the first inner wall 310 or by being in direct contact with the first inner wall 310.

An end portion of the first stopper 330 may be disposed to face a lower end portion of the first pressing bracket 510.

The pressing member 500 according to embodiments may further include a first slit 513.

The first slit 513 may function as a configuration providing a connection between the first pressing bracket 510 and the first stopper 330.

The first slit 513 according to embodiments may have a hole shape passing through the first pressing bracket 510. More specifically, the first slit 513 may pass through the first flange 511, located at the lower side among the pair of first flanges 511 spaced apart in the third direction, along the first direction.

The end portion of the first stopper 330 disposed to face the lower end portion of the first pressing bracket 510 may be inserted into the first slit 513. Accordingly, the first pressing bracket 510 may maintain an upright state in the slot 301.

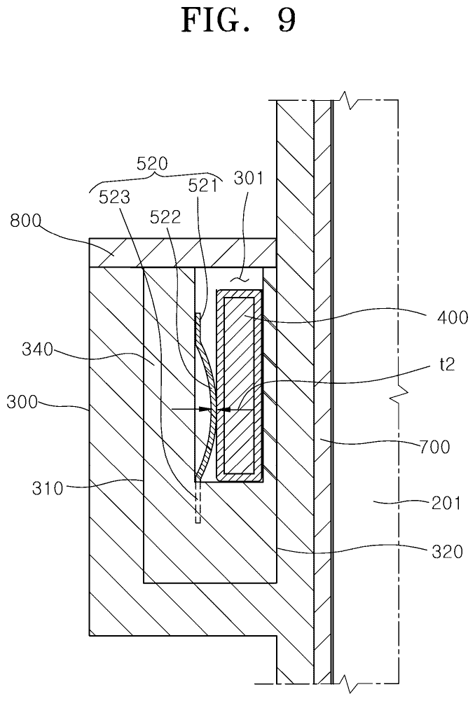

FIG. 9 is a cross-sectional view taken along line IX-IX′ in FIG. 6.

Referring to FIGS. 1 to 9, the pressing member 500 according to embodiments may further include a second pressing bracket 520.

The second pressing bracket 520 may be disposed between the first inner wall 310 and the stack bus bar 400. The second pressing bracket 520 may be spaced apart from the first pressing bracket 510 along the second direction or an opposite direction of the second direction. A distance from the center line C of the battery cell 201 to the second pressing bracket 520 may be greater than a distance from the center line C of the battery cell 201 to the first pressing bracket 510. For example, the center line C of the battery cell 201 passing through the center of the battery cell 201 along the first direction may pass through the first pressing bracket 510, and the second pressing bracket 520 may be disposed at a position spaced apart from the center line C of the battery cell 201 along the second direction or the opposite direction of the second direction.

A plurality of second pressing brackets 520 may be provided. The plurality of second pressing brackets 520 may be symmetrically disposed on both sides of the first pressing bracket 510. In embodiments, a pair of second pressing brackets 520 may be disposed spaced apart from each other in the second direction and the opposite direction of the second direction on both sides of one first pressing bracket.

The second pressing bracket 520 may press the stack bus bar 400 toward the second inner wall 320 at a position spaced apart from the first pressing bracket 510. The second pressing bracket 520 may be provided to be elastically deformable. Accordingly, the second pressing bracket 520 may always apply a pressing force to the stack bus bar 400 by its own elastic force without a separate power device.

A thickness t1 of the first pressing bracket 510 may be smaller than a thickness t2 of the second pressing bracket 520. That is, an elastic coefficient of the first pressing bracket 510 facing a center region of the battery cell 201 having a relatively large expansion rate during thermal runaway of the battery cell 201 may be formed to be relatively lower than an elastic coefficient of the second pressing bracket 520. Accordingly, when thermal runaway occurs in the battery cell 201, the first pressing bracket 510 and the second pressing bracket 520 may apply a uniform pressing force to the stack bus bar 400.

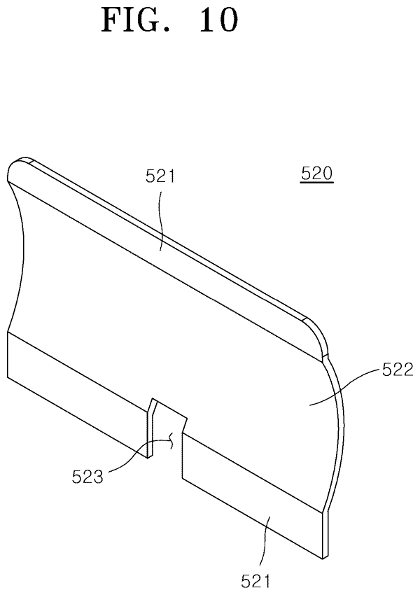

FIG. 10 is a perspective view schematically showing a configuration of the second pressing bracket according to embodiments of the present disclosure.

Referring to FIGS. 1 to 10, the second pressing bracket 520 according to embodiments may include a second flange 521 and a second bent portion 522.

The second flange 521 may form an exterior of one side of the second pressing bracket 520 and support the second bent portion 522.

The second flange 521 according to embodiments may have a flat plate shape disposed parallel to the first inner wall 310. A pair of second flanges 521 may be provided. The pair of second flanges 521 may be disposed spaced apart from each other at a certain interval along the third direction.

The second bent portion 522 may be connected to the second flange 521 and may form an exterior of a center of the second pressing bracket 520.

The second bent portion 522 according to embodiments may be disposed between the pair of second flanges 521. Both end portions of the second bent portion 522 may be connected to different second flanges 521, respectively. The second bent portion 522 may be convexly bent toward the stack bus bar 400 around the second direction. The second bent portion 522 may be in contact with the stack bus bar 400 and may press the stack bus bar 400 toward the second inner wall 320 by an elastic force due to the bending.

The end plate 300 according to embodiments may further include a second stopper 340 for supporting the second pressing bracket 520 in the slot 301. A plurality of second stoppers 340 may be provided. The plurality of second stoppers 340 may be disposed spaced apart from the first stopper 330 in the slot 301. Each of the second stoppers 340 may individually support different second pressing brackets 520.

The second stopper 340 according to embodiments may have a form of a partition wall extending from the first inner wall 310 toward the inner space of the slot 301. The pair of second flanges 521 may be supported by being in contact with a surface of the second stopper 340 disposed parallel to the first inner wall 310 or by being in direct contact with the first inner wall 310.

An end portion of the second stopper 340 may be disposed to face a lower end portion of the second pressing bracket 520.

The pressing member 500 according to embodiments may further include a second slit 523.

The second slit 523 may function as a configuration providing a connection between the second pressing bracket 520 and the second stopper 340.

The second slit 523 according to embodiments may have a hole shape passing through the second pressing bracket 520. More specifically, the second slit 523 may pass through the second flange 521, located at the lower side among the pair of second flanges 521 spaced apart in the third direction, along the first direction.

The end portion of the second stopper 340 disposed to face the lower end portion of the second pressing bracket 520 may be inserted into the second slit 523. Accordingly, the second pressing bracket 520 may maintain an upright state in the slot 301.

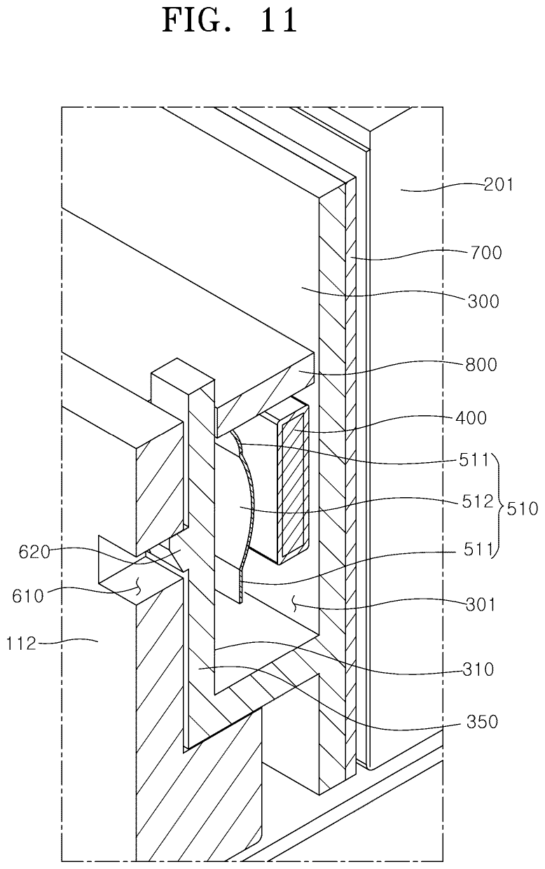

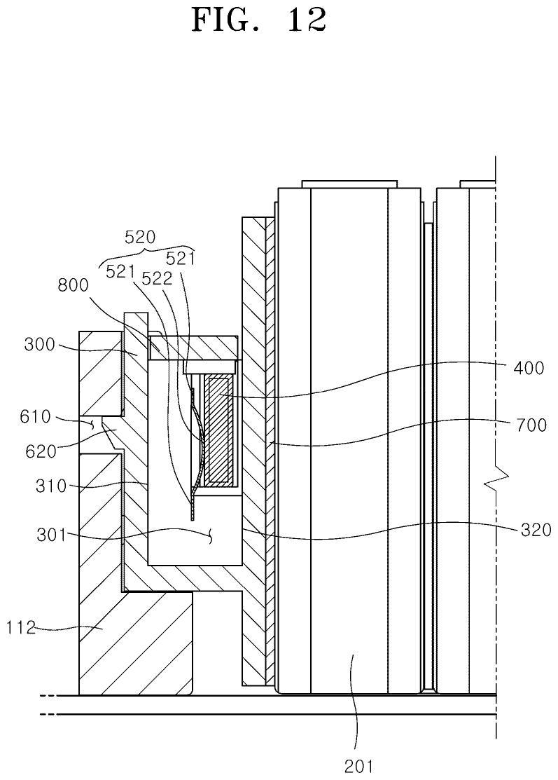

FIG. 11 is a perspective view schematically showing a configuration of a fastening hole and a hook according to embodiments of the present disclosure, and FIG. 12 is a cross-sectional view schematically showing the configuration of the fastening hole and the hook according to embodiments of the present disclosure.

Referring to FIGS. 11 and 12, the battery pack according to embodiments may further include a fastening hole 610 and a hook 620 for fixing the end plate 300 to the second frame 112.

The fastening hole 610 according to embodiments may have a hole shape passing through the second frame 112 along the first direction. A cross-sectional shape of the fastening hole 610 may be designed to have various shapes such as a circular shape, an oval shape, and the like in addition to the quadrangular shape shown in FIG. 11.

The hook 620 according to embodiments may protrude from the end plate 300. The hooks 620 may be inserted into the fastening hole 610 as an outer side surface of the end plate 300 is disposed to face an outer side surface of the second frame 112. The shape of the hook 620 may be designed to have various shapes which may be hook-coupled to the fastening hole 610 in addition to the shapes shown in FIGS. 11 and 12.

The end plate 300 according to embodiments may further include a fastening body 350 which supports the hook 620.

The fastening body 350 according to embodiments may be exemplified as a partial region of the end plate 300 where the hook 620 protrudes among an entire region of the end plate 300.

The fastening body 350 may be provided to be elastically deformable along the first direction. For example, a pair of through holes passing through the end plate 300 along the first direction may be disposed spaced apart from each other along the second direction on both sides of the fastening body 350. Accordingly, when the second frame 112 and the end plate 300 are fastened or separated, a user may elastically deform the fastening body 350 in the first direction or in the opposite direction of the first direction to allow the hook 620 to be inserted into the fastening hole 610 or separated from the fastening hole 610. Further, after the hook 620 is inserted into the fastening hole 610, the fastening body 350 may be in close contact with the second frame 112 by its own elastic restoring force to prevent the hook 620 from being arbitrarily separated from the fastening hole 610.

In FIGS. 11 and 12, an example in which one fastening hole 610, one hook 620, and one fastening body 350 are formed is shown, but the present disclosure is not limited thereto, and a plurality of fastening holes 610, a plurality of hooks 620, and a plurality of fastening bodies 350 may be formed.

The battery pack according to embodiments may further include a reinforcement member 700.

The reinforcement member 700 may be connected to the end plate 300 and may reinforce the mechanical rigidity of the end plate 300.

The reinforcement member 700 according to embodiments may be disposed between the end plate 300 and the cell stack 200. The reinforcement member 700 may have a flat plate shape disposed perpendicular to the first direction. One surface of the reinforcement member 700 may be in contact with one surface of the end plate 300 facing the cell stack 200. The other surface of the reinforcement member 700 may be in contact with the second side portion 223 of the outermost battery cell 201 among of the battery cells 201 arranged in the cell stack 200 along the first direction. The reinforcement member 700 may be coupled to the end plate 300 by various coupling methods such as insert injection, welding, bolting, and the like.

The reinforcement member 700 may be formed of a material having higher rigidity than the end plate 300. For example, as the end plate 300 is formed of a plastic material such as polypropylene, the reinforcement member 700 according to embodiments may be formed of a metal material such as steel, aluminum, or the like.

The battery pack according to embodiments may further include a slot cover 800.

The slot cover 800 may be coupled to the end plate 300 and may seal the slot 301.

The slot cover 800 according to embodiments may have a flat plate shape disposed perpendicular to the third direction. The slot cover 800 may be disposed to face an open upper side surface of the slot 301. An area of the slot cover 800 may be greater than an area of the open upper side surface of the slot 301. A lower surface of the slot cover 800 may be seated on the upper side surface of the end plate 300. The slot cover 800 may be fixed to the end plate 300 by various types of coupling methods such as hook coupling, bolting, welding, fitting, and the like. A material of the slot cover 800 may be formed of the same material as the material of the end plate 300.

Hereinafter, a battery pack according to embodiments of the present disclosure will be described.

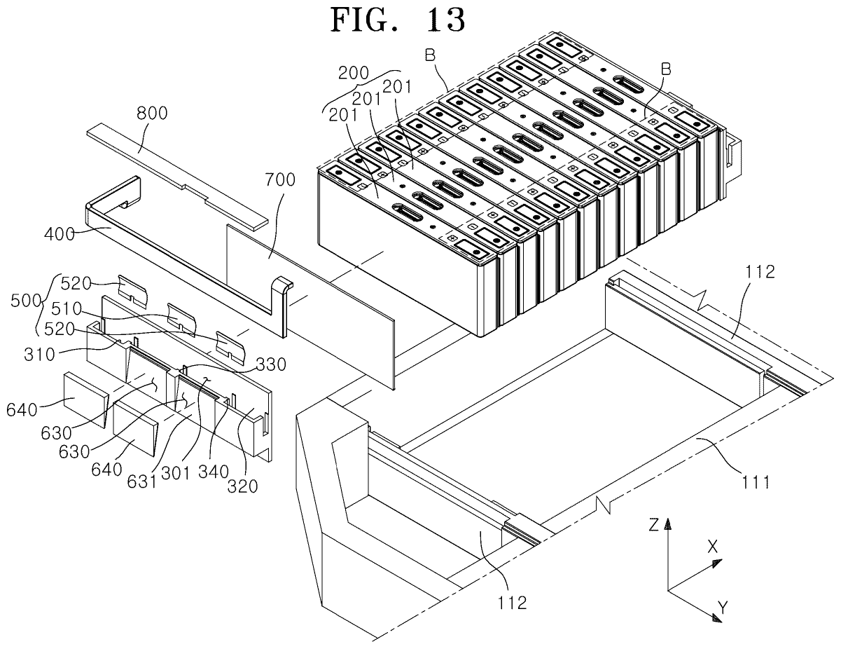

FIG. 13 is an exploded perspective view schematically showing a configuration of a battery pack according to embodiments of the present disclosure.

Referring to FIG. 13, the battery pack according to embodiments may further include a fixing member 640.

The battery pack according to embodiments may be configured to differ from the battery pack according to embodiments of the present disclosure only in that it further includes the fixing member 640.

Accordingly, in the description of the battery pack according to embodiments, only the fixing member 640 not described in the battery pack according to embodiments of the present disclosure will be described.

The description of the battery pack according to embodiments of the present disclosure may be applied as is to the remaining configuration of the battery pack according to embodiments.

In FIG. 13, an example in which the battery pack according to embodiments is configured not to include a fastening hole 610, a hook 620, and a fastening body 350 is described, but the battery pack according to embodiments is not limited thereto, and may be configured to include all the fastening hole 610, the hook 620, and the fastening body 350.

A fixing member 640 may be disposed between a second frame 112 and an end plate 300. The fixing member 640 may press the end plate 300 toward a cell stack 200. That is, the fixing member 640 may function as a configuration which firmly fixes the end plate 300 between the second frame 112 and the cell stack 200.

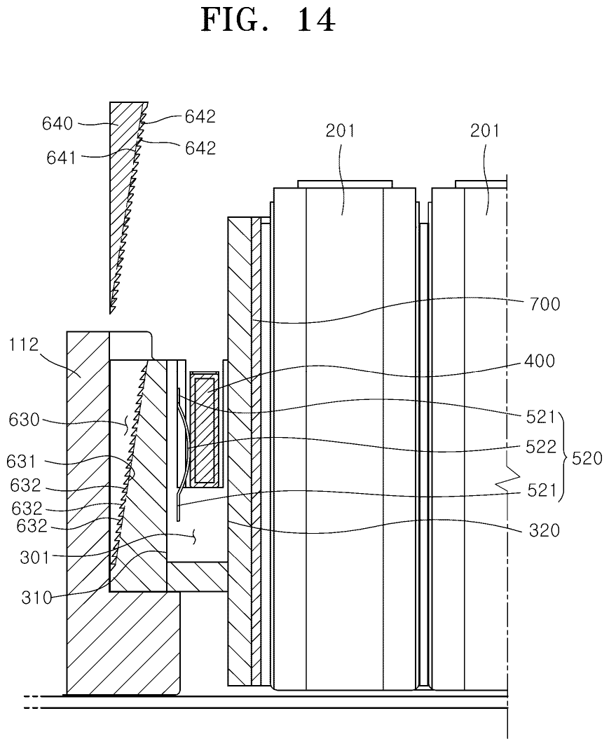

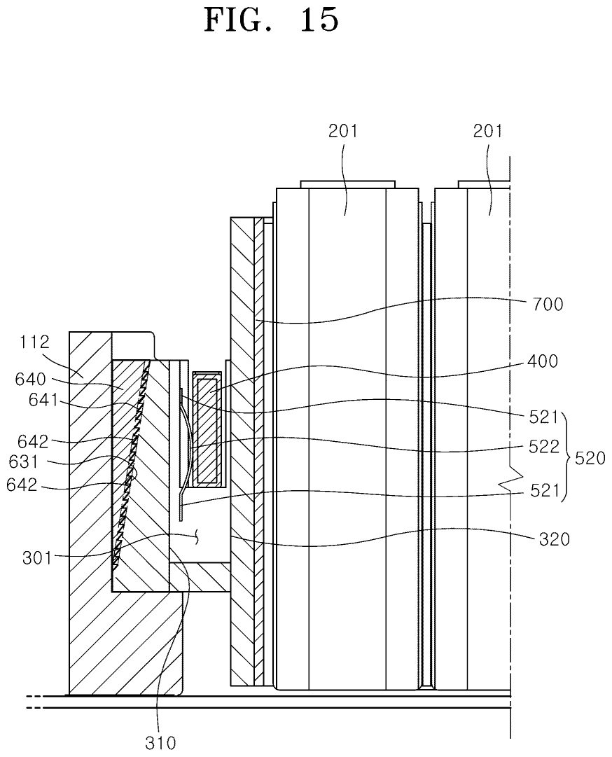

FIG. 14 is a cross-sectional view schematically showing a configuration of the fixing member according to embodiments of the present disclosure, and FIG. 15 is a view showing a state in which the fixing member is disposed between the second frame and the end plate in FIG. 14.

Referring to FIGS. 13 to 15, the fixing member 640 according to embodiments may be inserted between the second frame 112 and the end plate 300 along the third direction. For example, an insertion groove 630 extending along the third direction is formed on an outer side surface of the end plate 300 facing the second frame 112, and the fixing member 640 may be inserted into the insertion groove 630.

A first inclined surface 641 may be formed on one surface of the fixing member 640 facing the end plate 300. The first inclined surface 641 may be disposed to be inclined at a certain angle with respect to an insertion direction of the fixing member 640, that is, the third direction. For example, the fixing member 640 may have a wedge shape whose cross-sectional area becomes progressively narrow toward a lower end portion. Accordingly, the fixing member 640 may progressively increase the pressing force against the end plate 300 as the fixing member 640 is inserted into the insertion groove 630.

A second inclined surface 631 may be formed on one side of the end plate 300 disposed to surround the insertion groove 630. The second inclined surface 631 may be disposed to be inclined at a certain angle with respect to the third direction. The second inclined surface 631 may be disposed parallel to the first inclined surface 641. As the fixing member 640 is inserted into the insertion groove 630, the second inclined surface 631 may be disposed to face the first inclined surface 641.

A plurality of fixing members 640 and a plurality of insertion grooves 630 may be provided. Each of the fixing members 640 may be individually inserted into different insertion grooves 630.

The battery pack according to embodiments may further include a first sawtooth 642 and a second sawtooth 632.

The first sawtooth 642 and the second sawtooth 632 may protrude from the first inclined surface 641 and the second inclined surface 631, respectively and may be engaged with and coupled to each other. The first sawtooth 642 and the second sawtooth 632 may function as a configuration which prevents the fixing member 640 from being separated from the insertion groove 630 after the fixing member 640 is inserted into the insertion groove 630.

A plurality of first sawteeth 642 and a plurality of second sawteeth 632 may be provided. The plurality of first sawteeth 642 may be arranged at a certain interval along the first inclined surface 641, and the plurality of second sawteeth 632 may be arranged at a certain interval along the second inclined surface 631.

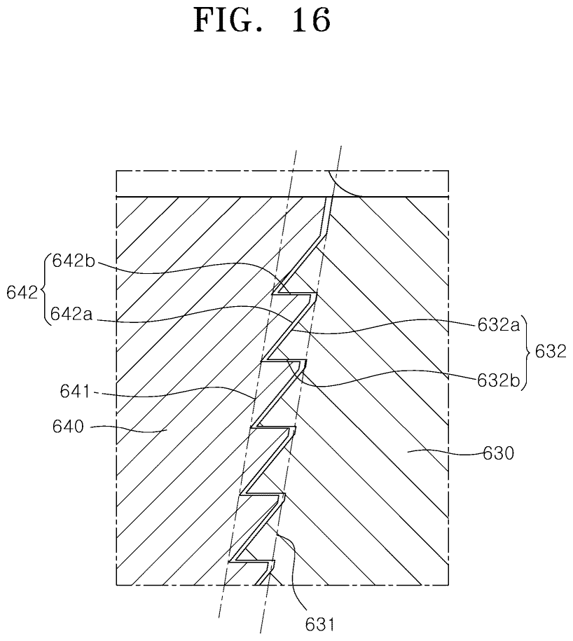

FIG. 16 is an enlarged view schematically showing a configuration of the first sawtooth and the second sawtooth according to embodiments of the present disclosure.

Referring to FIG. 16, the first sawtooth 642 according to embodiments may include a first guide surface 642a extending to be inclined from the first inclined surface 641 toward the second inclined surface 631, and a first catch surface 642b extending from the first guide surface 642a toward the first inclined surface 641.

The second sawtooth 632 according to embodiments may include a second guide surface 632a which extends to be inclined from the second inclined surface 631 toward the first inclined surface 641 and is disposed parallel to the first guide surface 642a, and a second catch surface 632b extending from the second guide surface 632a toward the second inclined surface 631 and in contact with the first catch surface 642b.

The first guide surface 642a and the second guide surface 632a may be disposed to be inclined with respect to the insertion direction of the fixing member 640, that is, the third direction. When the fixing member 640 is inserted into the insertion groove 630, the first guide surface 642a and the second guide surface 632a may be in mutual contact with each other and may guide an insertion operation of the fixing member 640.

The first catch surface 642b and the second catch surface 632b may be disposed perpendicular to the third direction. When the fixing member 640 is inserted into the insertion groove 630, the first catch surface 642b and the second catch surface 632b may be in mutual contact with each other to prevent the fixing member 640 from being separated from the insertion groove 630.

According to the present disclosure, as a stack bus bar connected to a cell stack is inserted into an end plate, an installation space of the stack bus bar can be reduced, and damage to the stack bus bar can be prevented.

According to the present disclosure, the stack bus bar can be firmly fixed to the inside of a slot by a pressing member which presses the stack bus bar.

According to the present disclosure, the end plate can be stably fixed between a housing and the cell stack through a fixing structure between the end plate and the housing.

According to the present disclosure, as the end plate is formed of a plastic material, weight reduction of a battery pack is possible.

However, the effects obtainable through the present disclosure are not limited to the herein effects, and other technical effects that are not mentioned will be clearly understood by those skilled in the art from the following description of the present disclosure.

While the present disclosure has been described with reference to embodiments shown in the drawings, these embodiments are merely illustrative and it should be understood that various modifications and equivalent other embodiments can be derived by those skilled in the art on the basis of embodiments.

What is claimed is:

1. A battery pack comprising:
a housing;
one or more cell stacks disposed in the housing and comprising a plurality of battery cells arranged along a first direction;
an end plate disposed to face the cell stack along the first direction;
a slot disposed in the end plate; and
a stack bus bar connected to the cell stack and inserted into the slot.

2. The battery pack as claimed in claim 1, further comprising a pressing member that is disposed in the slot and presses the stack bus bar.

3. The battery pack as claimed in claim 2, wherein the end plate comprises a first inner wall and a second inner wall disposed to face the slot and spaced apart from one another along the first direction, and
the pressing member comprises a first pressing bracket that is disposed between the first inner wall and the stack bus bar and presses the stack bus bar toward the second inner wall.

4. The battery pack as claimed in claim 3, wherein the first pressing bracket is elastically deformable.

5. The battery pack as claimed in claim 4, wherein the first pressing bracket comprises:
a first flange disposed parallel to the first inner wall; and
a first bent portion connected to the first flange, bent around a second direction intersecting the first direction, and in contact with the stack bus bar.

6. The battery pack as claimed in claim 3, wherein the end plate further comprises a first stopper that extends from the first inner wall to an inside of the slot and supports the first pressing bracket.

7. The battery pack as claimed in claim 6, wherein the pressing member further comprises a first slit passing through the first pressing bracket, and
the first stopper is inserted into the first slit.

8. The battery pack as claimed in claim 3, wherein the pressing member further comprises a second pressing bracket spaced from the first pressing bracket along a second direction intersecting the first direction.

9. The battery pack as claimed in claim 8, wherein a distance from a center line of the battery cell to the second pressing bracket is greater than a distance from the center line of the battery cell to the first pressing bracket.

10. The battery pack as claimed in claim 9, wherein a plurality of second pressing brackets are provided, and
the plurality of second pressing brackets are symmetrically disposed on both sides of the first pressing bracket.

11. The battery pack as claimed in claim 10, wherein a thickness of the first pressing bracket is smaller than a thickness of at least one of the second pressing brackets.

12. The battery pack as claimed in claim 1, wherein the housing comprises:
a housing body;
a first frame disposed in the housing body and extending along the first direction; and
a second frame disposed in the housing body and extending along a second direction intersecting the first direction, and
the end plate is disposed between the second frame and the cell stack.

13. The battery pack as claimed in claim 12, further comprising:
a fastening hole passing through the second frame; and
a hook protruding from the end plate and inserted into the fastening hole.

14. The battery pack as claimed in claim 13, wherein the fastening hole passes through the second frame along the first direction, and
the end plate comprises a fastening body that supports the hook and is elastically deformable along the first direction.

15. The battery pack as claimed in claim 12, further comprising a fixing member that is disposed between the second frame and the end plate and presses the end plate toward the cell stack,
wherein the fixing member is inserted between the second frame and the end plate along a third direction intersecting the first direction and the second direction.

16. The battery pack as claimed in claim 15, wherein the fixing member comprises a first inclined surface disposed to be inclined with respect to the third direction, and
the end plate comprises a second inclined surface disposed parallel to the first inclined surface.

17. The battery pack as claimed in claim 16, further comprising:
a plurality of first sawteeth protruding from the first inclined surface; and
a plurality of second sawteeth protruding from the second inclined surface and engaged with and coupled to the first sawteeth.

18. The battery pack as claimed in claim 1, further comprising a reinforcement member disposed between the end plate and the cell stack.

19. The battery pack as claimed in claim 18, wherein the end plate is formed of a plastic material, and
the reinforcement member is formed of a metal material.

20. The battery pack as claimed in claim 1, further comprising a slot cover that is coupled to the end plate and seals the slot.
